(19) United States
(12) Patent Application Publication
(10) Pub. No.: US 2018/0106653 A1
(43) Pub. Date: Apr. 19, 2018

(54) MONITORING SYSTEM FOR A CENTRAL VACUUM ASSEMBLY

(71) Applicant: RAVE SYSTEMS, INC., Hampton Bays, NY (US)

(72) Inventors: Dennis Finnerty, Southampton, NY (US); Sean Finnerty, Southampton, NY (US)

(21) Appl. No.: 15/556,704

(22) PCT Filed: Mar. 11, 2016
(86) PCT No.: PCT/US16/22007

§ 371 Date: Sep. 8, 2017

Related U.S. Application Data
(60) Provisional application No. 62/131,828, filed on Mar. 11, 2015.

(51) Int. Cl. G01F 3/22; A47L 9/28; A47L 9/19; A47L 5/38

(52) U.S. Cl. CPC G01F 3/22; A47L 9/28; G06F 3/14; A47L 5/38; A47L 9/19

(57) ABSTRACT

A service network, and associated methods, for monitoring central vacuum assemblies at distinct sites that include one or more air flow meters at each distinct site, each air flow meter respectively positioned and adapted to measure an indicia of air flow in connection with a particular central vacuum assembly within the service network; interfaces at the distinct sites associated with each air flow meter to relay an abnormal result from the respective air flow meter; and an off-site service center in communication with the interfaces at the distinct sites to register the abnormal result and identify the site of the abnormal result.

### CROSS REFERENCE TO RELATED APPLICATIONS

This patent application claims priority to U.S. Provisional Application Ser. No. 62/131,828, filed Mar. 11, 2015, entitled “Monitoring System for a Central Vacuum Assembly,” which is hereby incorporated by reference in its entirety as part of the present disclosure.

### FIELD OF THE INVENTION

The present disclosure relates to a central vacuum assembly.

### BACKGROUND INFORMATION

A household vacuum cleaner typically consists of a mechanical tank which employs a motor to create negative air pressure (vacuum). The negative air pressure draws dirt into a collection tank located directly adjacent to the motor utilizing a flexible hose terminated with a variety of implements designed to facilitate the gathering of debris into the orifice of the hose. The vacuum cleaner is pulled around behind the user to bring it into direct contact with the area needing to be cleaned.

A central vacuum assembly modifies this operation by locating the motor and collection tank in a remote area of the residence (basement, garage, mechanical closet, etc. . . . ), running PVC conduit throughout the enclosed walls of the structure (similar to plumbing) to various termination points throughout the house. The termination points, commonly called “outlets”, “inlets”, and “ports”, are designed with hinge activated doors to which a flexible hose is inserted and brought to the area to be cleaned. The cleaning implements are, for the most part, generally the same used in portable household vacuum cleaners.

### SUMMARY OF THE INVENTION

Central vacuum assemblies offer a number of advantages over standard, portable household vacuum cleaners. Central vacuum assemblies are not hindered by the need for portability and the need to pull the motor and collection tank behind the user; thus allowing for the utilization of a much stronger, heavier-duty motor. Even when factoring the increased length of conduit from the power source to the area needing to be cleaned, significantly increased suction power can be provided by central vacuum assemblies.

Further, a vacuum cleaning process involves depositing dirt-laden air into a collection container before being discharged back into the room though the discharge port of the vacuum motor. The waste air contains minor residue of otherwise static dirt found on surfaces and converts it into windblown, airborne particulate matter. This airborne particulate matter is known to be heavily-laden with dust mites, allergens, and pathogens, and easily enters the human respiratory system, causing allergic reactions, asthmatic incidents, and other deleterious health effects. Removable filters commonly found on portable vacuum cleaners are marginally effective in removing a small percentage of these elements, and lose most of their effectiveness if not vigorously maintained. In addition, homes with forced air heating or air conditioning will gather these pathogens and circulate them throughout the entire structure via their ductwork. Having the motor and collection in a remote, utility or “non-living” area of the home in a central vacuum assembly prevents the discharge of this offensive and dangerous material back into the living area, thereby creating a much healthier indoor environment. In many cases the waste air can be discharged from the home entirely similar to a clothes dryer.

While central vacuum assemblies offer many advantages, there remain limitations. Every vacuum cleaning method, both portable and central, rely on proper suction to draw dirt into the collection tank. Primary causes of lost suction can include: improper machine maintenance (clogged filter, overfilled tank, etc.), motor malfunction, blockage in the hose/conduit line, and outside air infiltration into the system, which can be the result of a cracked hose, missing wall plate, broken or cracked conduit line, etc. A portable vacuum cleaner, because of its close proximity to the user, allows for the immediate diagnosis and correction of suction loss. The dirt receptacle can be promptly emptied, a cracked hose is instantly apparent and corrected, and a malfunctioning motor presents itself through sound, a burning electrical smell, and often times carbon residue. In summary, the portable vacuum cleaner instantly presents its problems to the user through audible, visual, and olfactory signals.

The suction loss in a central vacuum assembly is much more difficult to detect and diagnose for a variety of reasons. First, the remote location of the power unit of a central assembly in a utility area prevents it from delivering auditory or visual signals to the user that the tank is malfunctioning. The user is unable to hear a grinding motor, detect a faint burning smell, or notice carbon residue on the machine. The remote location of the power unit in a utility area also area makes proper power unit maintenance less likely, and also allows for a greater likelihood of clogging between the power source and cleaning terminus. Large homes, in particular, typically have a delineation of duties between the users of the central vacuum assembly (cleaning staff), and the caretakers/maintenance personnel who change filters and undertake light maintenance duties within a house. A house cleaner who might typically address a problem with a portable vacuum (tighten a hose, change the bag, alert someone to an obvious malfunction) will often times continue to operate the central vacuum assembly with reduced air flow, uncertain as to the cause, or even the existence of diminished suction. Further, what constitutes proper suction is highly subjective, and even malfunctioning central systems can often perform at a similar capacity as many portables. Unlike portable vacuums, which have a direct single and short line from the vacuum source to the cleaning terminus, the central vacuum system is dependent on the sealed integrity of hundreds of feet of sealed PVC conduit running through the house. Any disruption to the conduit and other wall terminations will result in diminished airflow at the cleaning source. The disruption may be located a great distance from the cleaning source, and not be readily apparent even to the trained eye. Some common disruptions to sealed airflow include, for example, a wall plate removed for painting and/or remodeling, a build out of wall surface for paneling or wood trim causing air space between wall plate and gasket behind wall, and a crack or disruption to the conduit during remodeling, and improper installation of collection bucket. Mindful of the inherent limitations of central vacuum assemblies, there remains a need to better monitor their performance, and efficiently manage their upkeep.

One aspect of the present invention provides a monitoring system for a central vacuum assembly at a site that includes (a) an air flow meter positioned and adapted to measure an indicia of air flow in connection with the central vacuum assembly; (b) an interface adapted to receive output from the air flow meter and relay an abnormal result; and (c) an off-site service center in communication with the interface to register the abnormal result. In one embodiment, the off-site service center is adapted to initiate remedial action at the site upon registering the abnormal result, which can be initiated based on a pre-determined, automated protocol. In one embodiment, the air flow meter is adapted to measure air flow, and the interface is adapted to relay the abnormal result when the measured air flow is below a first pre-determined level (e.g. about 80 CFM in a typical residential site), and/or above a second pre-determined level (e.g., about 100 CFM in a typical residential site). The interface can be located at the site, or in near proximity to the site. The interface can be placed in communication with the off-site service center via a WiFi connection associated with the site (e.g., connection to a residential WiFi server).

The monitoring system can further include a UI to display output regarding a status of the monitoring system. The interface and UI can be incorporated together or can be separately located as separate components. Also, the interface can be incorporated with the air flow meter as one unit. In one embodiment, the interface or the UI does not display any indication of the abnormal result. The air flow meter and the interface can be incorporated as an integrated manufactured component of the central vacuum assembly power unit.

As further explained below, the off-site service center can be, and usually is, in further communication with one or more additional interfaces, located at one or more additional sites. Thus a network of central vacuum assemblies can be monitored. Within the network of monitored central vacuum assemblies, the off-site service center can be adapted to identify the location of the site upon registering the abnormal result, and can further include notification means to notify an owner of the site of an abnormal result. Another aspect of the present invention provides a method of monitoring a central vacuum assembly at a site that includes (a) measuring an indicia of air flow in connection with the central vacuum assembly; (b) receiving output from the air flow meter and relaying an abnormal result via an interface; (c) registering the abnormal result at an off-site service center in communication with the interface. The method can further include initiating remedial action for the site upon registering the abnormal result, which can be initiated based on a pre-determined, automated protocol.

Another aspect of the present invention provides a service network for monitoring central vacuum assemblies at distinct sites that includes one or more air flow meters at each distinct site, with each air flow meter respectively positioned and adapted to measure an indicia of air flow in connection with a particular central vacuum assembly within the service network; (b) interfaces at the distinct sites associated with each air flow meter to relay an abnormal result from the respective air flow meter; and (c) an off-site service center in communication with the interfaces at the distinct sites to register the abnormal result and identify the site of the abnormal result. For example, the off-site service center can be adapted to automatically notify an owner of the site where the abnormal result is registered, and/or institute remedial action at the site from where the abnormal result is registered.

Another aspect of the present invention provides a method of monitoring a network of central vacuum assemblies at distinct sites that includes (a) locating one or more air flow meters at each distinct site to measure an indicia of air flow in connection with central vacuum assemblies within the network; (b) relaying an abnormal result from the one or more air flow meters at an interface associated with each one or more air flow meters; (c) communicating the abnormal result to an off-site service center.

### BRIEF DESCRIPTION OF THE DRAWINGS

The foregoing features of the disclosure will be apparent from the following Detailed Description of the Invention, taken in connection with the accompanying drawings, in which:

FIG. 1 is a depiction of an air flow meter and interface according to one non-limiting embodiment of the present disclosure;

FIG. 2 is a depiction of an internal cross-section of a central vacuum assembly conduit, demonstrating the use of lasers to measure air watts for the air flow through the conduit;

FIG. 3 is a schematic of the air flow meter and interface in use within a central vacuum assembly monitoring network.

### DETAILED DESCRIPTION OF THE INVENTION

Central vacuum assemblies that can be monitored using the instantly disclosed methods and systems are known in the art (see, e.g., U.S. Pat. No. 6,120,615, hereby incorporated by reference). Existing vacuum assemblies can be retrofitted to provide the instantly disclosed features, or they can be incorporated as a component to newly installed assemblies. Air flow meters are also known in the art. Existing flow meters can be adapted for use in the present invention, or air flow meters can be specifically developed, based on existing technology known to those of ordinary skill in the art, for use in the presently disclosed methods and systems. Air flow meters for use in the present invention can be obtained from, and implemented by, approved agents from, for example, Dwyer Instruments (Michigan City, Ind.), Omega Engineering (Stamford, Conn.), PCE Americas (Palm Beach, Fla.) and EEsiFlo (Mechanicsburg, Pa.). According to one embodiment, the air flow meter incorporates the use of lasers to measure air watts, which is an indicia of air flow commonly used in the vacuum industry. More particularly, an air watt is a mathematical measurement of vacuum pressure and airflow. Air watt ratings provide a useful cleaning performance value of a vacuum because they specify the relationship of lifting ability and dirt moving ability.

The air flow meters can be placed, by one with ordinary skill in the vacuum and HVAC arts, along ducts that are central to the system, such as just upstream from the power unit/collection tank. The air flow meters can be further provided with a clock function, so as to be able to measure and indicia of air flow as a function of time. In addition to measuring an indicia of air flow or suction, motor load, system pressures, and other process variables can also be measured and transmitted, via the interface, to the off-site service center.

In certain embodiments, the interface is incorporated within the air flow 5 unit to receive output from the air flow meter, and this interface communicates with the off-site service center to relay the results from the air flow meter. Optionally, particularly when the present system and methods are used to monitor a relatively large central vacuum assembly, additional flow meters, also in communication with the interface, can be provided further upstream at additional locations within a given site to provide additional granularity (e.g., to be able to identify, with particularity, where in the central vacuum assembly upstream blockages are occurring).

In one embodiment, the air flow meter is attached to the intake of the power unit and detects a loss of airflow due to a blockage somewhere in the hose or conduit line, loss of power from the power unit, or a disruption of the sealed suction in the system. As one non-limiting example, if a typical central vacuum assembly delivers 90 cubic feet per minute (CFM) near the power unit, the air flow meter will be located so as to measure air flow near the inlet, and can break down the diminished airflow into two essential components: (a) provided the integrity of the conduit/vacuum line is intact, a blockage or clogged filter will allow the air flow indicator to rise to its full 90 CFM—although its sluggish rise to full scale will indicate a problem; (b) a disruption to the conduit integrity will prevent the meter from rising to its full sealed reading. For example, a missing wall plate in another area of the house may only allow the recorded air flow to rise to 45 CFM, whereas a missing plate and broken conduit may only allow a rise to 28 CFM, etc. In one embodiment, the air flow meter emits constant operational feedback via a micro-transmitter to an interface located, for example, near the flow meter, or alternatively, in a utility closet, pantry, or other remote location. It is not necessary to have the interface, or a UI, near the vacuum power source. Once a loss of airflow is detected, the interface digitalizes the loss into a signal and send it to a off-site service center via the home WiFi network. In one preferred embodiment, indication of an abnormal result (such as a measured reduced airflow) will not be indicated on the interface, or an UI, or any other display located at the site (e.g., home) where the central vacuum assembly is located, as will be explained below.

In certain embodiments, once an abnormal result is received and registered at the off-site service center (e.g., a registered low suction signal that is registered by the off-site service center) the location of the site (e.g., residence) is determined and the home or site owner will be alerted by a pre-approved method (phone call, text message, email, postcard) that their system is experiencing a loss of suction, the type of air loss (suction integrity or blockage), and inquire as to the desirability of a service call by a repairman. If a service call is requested, the local repair provider will be contacted to schedule the appointment at a mutually convenient time, and a fee will be collected from the repair provider.

Centralization of central vacuum services provides the ability to elicit referral fees and/or price-reductions from technicians who will be dispatched to fix the central vacuum assemblies in the service network. Technicians, wanting to obtain a higher volume of work, will accept paying such a commission, or reducing their price charged to site owners. Revenues obtained from service providers can, in turn, help reduce, or even eliminate, any instillation and/or user fees that are charged to clients, which in turn, will increase the subscriber base, leading to increased negotiation leverage with technicians. As noted above, according to one non-limiting embodiment, indication of an abnormal result (such as a measured reduced airflow) will not be indicated on the interface, or an UI or any other display located at home where the central vacuum assembly is located. Notification of air loss to the immediate user is likely to be ineffectual. Many of the personnel involved in residential cleaning are not well versed in technical issues, and may be confused with an indicator device, and how to respond once a problem is indicated. There is a high likelihood that suction loss will be ignored as a maintenance issue, and there is no certainty that a maintenance person will actually be notified. There may also be a language barrier in communicating information as well. Finally, there is often complacency on the part of cleaning staff to address problems in order to maximize speed and operate the equipment, even in a diminished capacity, in order to finalize the operation and move onto the next task. There will be a reluctance to pause or delay operations in order to address a maintenance issue. Direct, and optionally exclusive, notification of the abnormal result (such as air loss) to the homeowner is the most desirable avenue. The homeowner retains a house cleaner to do the most thorough job possible, and it is in their best interest to make sure equipment is running at optimal strength to properly complete the task for which they are paying. Equally important—a disruption to the conduit line during renovation or alteration must be immediately addressed to avoid the danger that the disruption is buried behind a finished wall thereby making it difficult and expensive to locate and repair at a future date. In such a renovation scenario, time is of the essence and without careful and consistent monitoring, and easily fixed problem can become quite costly to fix if not timely addressed.

Notification directly to a local service provider would not afford the full array of services and options available to a centralized off-site service center. Some local service providers may lack the equipment and personnel to properly respond to a low suction signal, but would be equipped to dispatch an on-site repairman. Centralization would allow for unified marketing, economy of scale, and prompt evaluation of customer satisfaction which, in turn, will aid in the proper selection of local service providers for future incidents. Alternate local service providers could be secured in the event of unsatisfactory response times or performance.

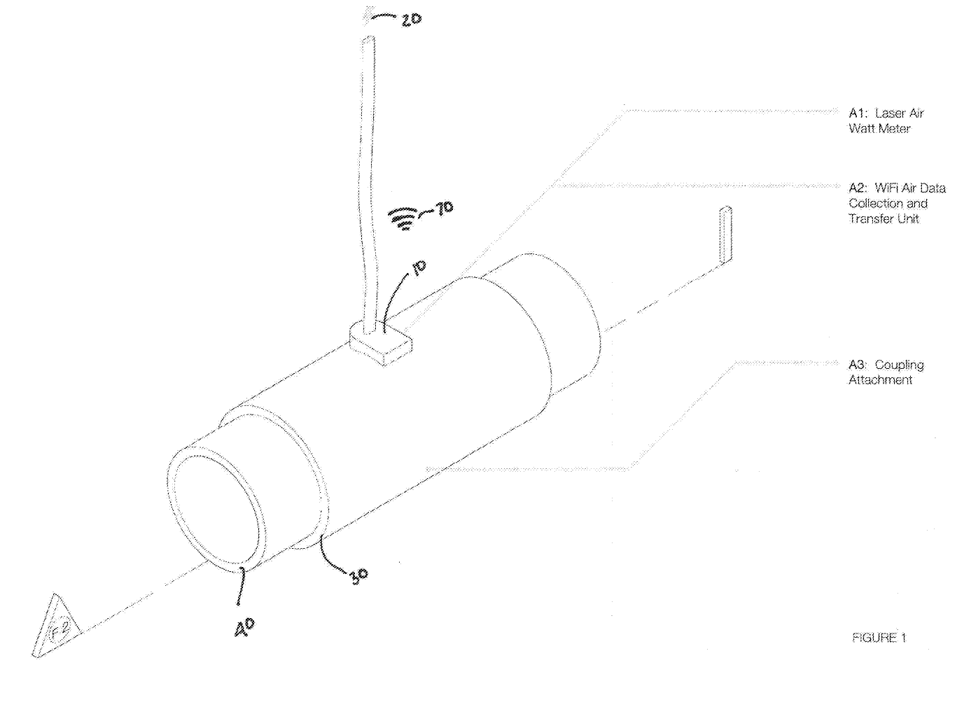

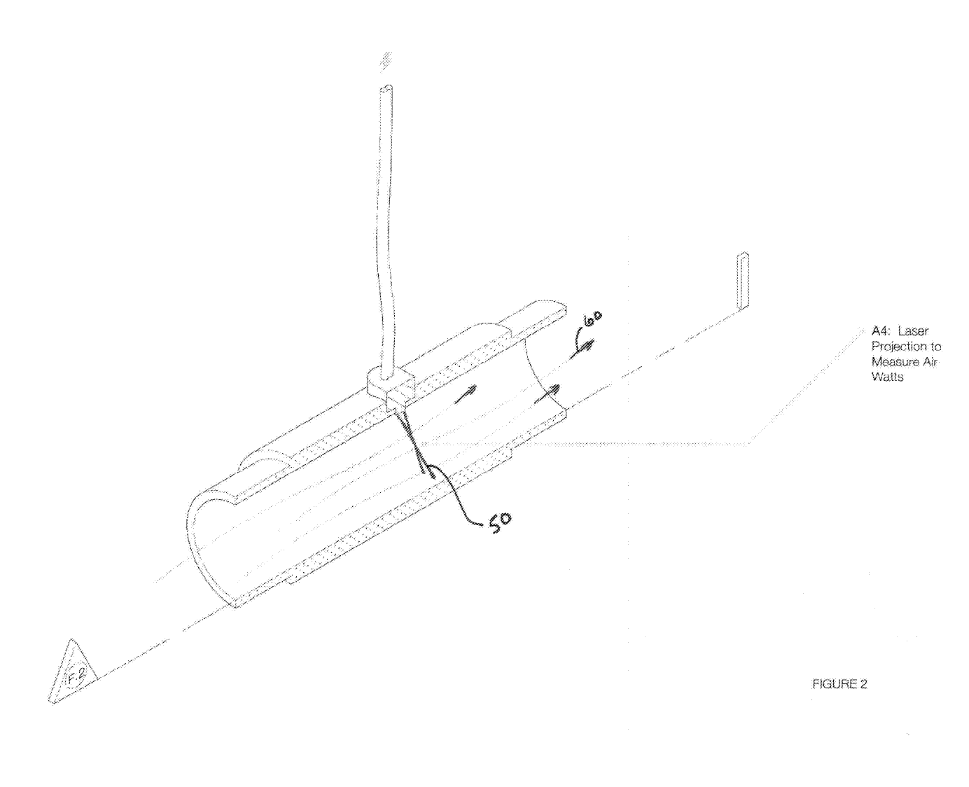

An exemplary air flow meter and interface according to one non-limiting embodiment of the presently disclosed subject matter is shown in the Figures, in which like numbers represent like elements throughout. FIG. 1 discloses an interface and air flow meter incorporated together as one unit (10), which is provided with a power source (20). The interface is adapted to communicate with an off-site service center via the site's WiFi connection (70). With the aid of a standard coupling attachment (30), the air flow meter/interface (10) is placed in close proximity to a central duct (40) of central vacuum assembly, which is typically PVC vacuum conduit. This location can be just upstream from the power unit/collection tank (80, FIG. 4). As shown in FIG. 2, the airflow meter used in this particular embodiment employs lasers (50) to measure air watts associated with the flow of air (60) through the central vacuum assembly.

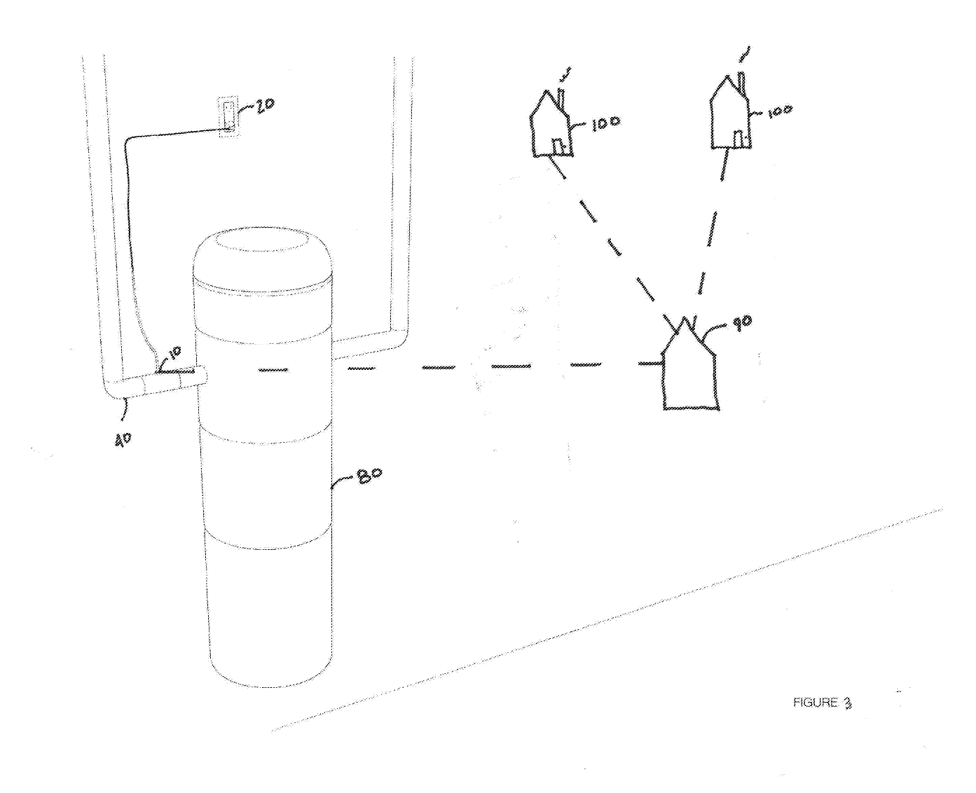

Having described the system components located at the site, interaction with the off-site service center (90) will now be described with reference to FIG. 3. The interface and air flow meter (10) is in communication with the off-site service center. While the details of one particular site have been disclosed, it is understood that the off-site service center is also in communication with various other interfaces located at various other sites (100), such as residences, that are also members of the service network. These various sites can be located in the same neighborhood, city, state, region, or they can be geographically diverse.

For example, the flow meter (10) can measure a flow rate, and transmit flow rate as a function of time to the interface, which is, in turn, in communication with the off-site service center (90). Communication between the interface and off-site service center is established upon application of routine skill in the process control and IT arts, provided that the interface and off-site service center are enabled with internet access. For example, the interface and off-site service center can be compliant with the Unified Architecture Specification adopted by the OPC Foundation, which sets forth standard data formats and security and access protocols so that its members (here, the various sites of the network and the off-site service center(s)) can build and implement systems that work together under a common framework. This is described in greater detail, for example, in U.S. Pat. No. 8,219,669, which is hereby incorporated by reference in its entirety.

When an abnormal result is communicated to the off-site service center by an interface, the off-site service center registers the result. Upon registering the result, the off-site service center can respond, according to one embodiment, according to based on a pre-determined, optionally automated, protocol.

Various pre-determined protocols can be presented to the client (e.g. a homeowner), and the client can select the proper protocol based on the level of involvement that he or she desires from the off-site service center. For example, the client (e.g., a homeowner) can elect to receive an automated text message or phone call notifying them of the abnormal result, or the client can elect a protocol in which, in addition to notification, the service center automatically arranges for a technician to arrive at the site upon registering an abnormal result. The service visit by a technician can be arranged based on input from the client, and/or arranged based on preferences previously communicated to the service center (e.g., arrange all service visits on Friday afternoon, after 2 p.m.). Still further, the client can, in certain embodiments, elect a protocol that provides still further participation from the off-site service center, in which, for example, a representative of the service center, who has previously been provided keys or entry clearance into the site will act as a concierge for the technician so the client's schedule is not disrupted or inconvenienced in any way.

Any central vacuum assembly can be included within the instantly described service networks. The site, or distinct sites as applicable, can include, or consist entirely of a residence, an office space, a restaurant or other food service facility, a retail location, a hotel or resort, a school, a municipal building or a public entertainment or assembly venue, such as casinos, arenas and other sports stadiums. In a preferred embodiment, the site is a residential unit, or the distinct sites consist of a plurality of residential units, as applicable. In certain embodiments, the central vacuum system is as currently defined and accepted by the American Institute of Architects (AIA). In one embodiment, the site, or distinct sites as applicable, do not include a manufacturing facility. As used herein, a manufacturing facility is a facility purposed for manufacturing, refining, processing or otherwise increasing the value of a tangible good or product that is manipulated within the facility, such as a chemical, food, beverage, pharmaceutical, electricity, paint product, motor vehicle, consumer product or the like. Manufacturing facilities include, but are not limited to, chemical plants, electrical and utility stations, and refineries.

Having thus described the disclosure in detail, it is to be understood that the foregoing description is not intended to limit the spirit or scope thereof. What is desired to be protected is set forth in the following claims.

1. A monitoring system for a central vacuum assembly at a site comprising:
(a) an air flow meter positioned and adapted to measure an indicia of air flow or suction in connection with the central vacuum assembly;
(b) an interface adapted to receive output from the air flow meter and relay an abnormal result; and
(c) an off-site service center in communication with the interface to register the abnormal result.

2. The monitoring system of claim 1, wherein the off-site service center is adapted to initiate remedial action at the site upon registering the abnormal result.

3. The monitoring system of claim 2, wherein said remedial action is initiated based on a pre-determined, automated protocol.

4. The monitoring system of claim 1, wherein the air flow meter is adapted to measure air flow, and the interface is adapted to relay the abnormal result when the measured air flow is below a first pre-determined level, and/or above a second pre-determined level.

5. The monitoring system of claim 4, wherein the site is a residential unit, and the first predetermined level is about 80 CFM, and/or the second predetermined level is about 100 CFM.

6. The monitoring system of claim 1, wherein the interface is located at the site, or in near proximity to the site.

7. The monitoring system of claim 1, further comprising a UI to display output regarding a status of the monitoring system.

8. The monitoring system of claim 7, wherein the interface and UI are incorporated together.

9. The monitoring system of claim 7, wherein the interface or the UI does not display any indication of the abnormal result.

10. The monitoring system of claim 1, wherein the interface and the airflow meter are incorporated as one unit.

11. The monitoring system of claim 1, wherein the air flow meter and the interface is incorporated as an integrated manufactured component of a power unit associated with the central vacuum assembly.

12. The monitoring system of claim 1, wherein the interface and the off-site service center are in communication, at least in part, via a WiFi connection.

13. The monitoring system of claim 1, wherein the off-site service center is in further communication with one or more additional interfaces, located at one or more additional sites.

14. The monitoring system of claim 13, wherein the off-site service center is adapted to identify the location of the site upon registering the abnormal result.

15. The monitoring system of claim 14, wherein the off-site service center includes notification means to notify an owner of the site.

16. A method of monitoring a central vacuum assembly at a site comprising:
(a) measuring an indicia of air flow or suction in connection with the central vacuum assembly;
(b) receiving output from the air flow meter and relaying an abnormal result via an interface;
(c) registering the abnormal result at an off-site service center in communication with the interface.

17. The method of claim 16, further comprising initiating remedial action for the site upon registering the abnormal result based on a predetermined, automated protocol.

18. (canceled)

19. The method of claim 16, wherein airflow is measured and the abnormal result is relayed when the measured air flow is below a first pre-determined level, and/or above a second predetermined level.

20. (canceled)

21. The method of claim 16, further comprising displaying output regarding a status of the monitoring system via a UI, wherein the UI does not display an indication of the abnormal result.

22. (canceled)

23. The method of claim 16, further comprising identifying the location of the site and notifying an owner of the site of the abnormal result.

24-31. (canceled)
